(19) United States
(12) Patent Application Publication
(10) Pub. No.: US 2016/0065120 A1
(43) Pub. Date: Mar. 3, 2016

(54) SOLAR CELL SUPPORT ASSEMBLY

(71) Applicant: BYD COMPANY LIMITED, Shenzhen, Guangdong (CN)

(72) Inventors: LONG HE, Shenzhen (CN); JIAOLIAN XU, Shenzhen (CN); HONGBIN WANG, Shenzhen (CN); YAOQIN HUANG, Shenzhen (CN); GUANGDI LI, Shenzhen (CN)

(21) Appl. No.: 14/785,008

(22) PCT Filed: May 14, 2014
(86) PCT No.: PCT/CN2014/077422

§ 371 Date: Oct. 16, 2015

(30) Foreign Application Priority Data
May 14, 2013 (CN) 201320261872.4

(51) Int. Cl. H02S 20/32; F16B 7/18

(52) U.S. Cl. CPC H02S 20/32; F16B 7/182

(57) ABSTRACT

A solar cell support assembly includes a plurality of support bases; swing bars; beams extended in a longitudinal direction and spaced from one another in a transverse direction, the beams connected to the plurality of the swing bars correspondingly, each of the beams rotatably supported on one of the plurality of support bases and adapted to mount solar panels, each of the beams comprising a hollow tube, and a wall thickness of each beam decreases gradually along a direction from a connecting position between the beam and the swing bar to two ends of the beam; a pushrod connected to the swing bars to drive the plurality of the swing bars to rotate the beams, respectively; and a driving device connected to the pushrod to drive the pushrod to move along the transverse direction.

### CROSS-REFERENCE TO RELATED APPLICATION

This application claims priority to, and benefits of Chinese Patent Application Serial No. 201320261872.4, filed with the State Intellectual Property Office of China on May 14, 2013, the entire content of which is incorporated herein by reference.

### FIELD

Exemplary embodiments of the present disclosure generally relate to a solar cell field, and more particularly to a solar cell support assembly.

### BACKGROUND

The solar cell support assembly in the related art includes two types: a fixed support and a tracking support. The tracking support is widely used, because it may enlarge the effective light absorption area, thus increasing the daily electric energy production of a solar cell.

With the conventional tracking support, one pushrod is driven by a driving device, thus the solar cell module is driven to rotate according to a position of the sun, so that a large force needs to be applied on the pushrod to drive the tracking support. Therefore, a lot of energy is consumed in order to track the sun. Moreover, the solar cell is unsafe since the ground subsidence may occur due to the heavy weight of the tracking support.

### SUMMARY

Embodiments of the present disclosure seek to solve at least one of the problems.

According to embodiments of the present disclosure, a solar cell support assembly is provided. The solar cell support assembly includes a plurality of support bases; a plurality of swing bars; a plurality of beams extended in a longitudinal direction and spaced from one another in a transverse direction, the plurality of the beams connected to the plurality of the swing bars correspondingly, each of the beams rotatably supported on one of the plurality of the support bases and adapted to mount solar panels thereon, each of the beams comprising a hollow tube, and a wall thickness of each beam decreasing gradually along a direction from a connecting position between the beam and the swing bar to two ends of the beam; a pushrod connected to the plurality of the swing bars to drive the plurality of the swing bars to rotate the plurality of the beams, respectively; and a driving device connected to the pushrod and configured to drive the pushrod to move along the transverse direction.

With one single driving device providing a driving force to all of the beams via the pushrod, a torque force applied on the plurality of the beams is distributed uniformly, therefore the torque force applied on each beam may decrease along the direction from the connecting position between the beam and the swing bar to two ends of the beam due to the decrease of load. Accordingly, the wall thickness of each beam may decrease along the direction from the connecting position between the beam and the swing bar to two ends of the beam, so that the material of the beam can be saved, a probability of the ground subsidence decreases because the weights of the beams decrease. The stability of the solar cell system can be improved, and the solar cell support assembly according to embodiments of the present disclosure is adapted to be used widely.

In some embodiments, each of the beams comprises a plurality of beam segments, and adjacent beam segments are connected with each other via at least one of a diameter-varying connecting member and a universal joint.

In some embodiments, the adjacent beam segments are connected with each other via a diameter-varying connecting member.

In some embodiments, adjacent beam segments of a part of the plurality beam segments are connected with each other via a diameter-varying connecting member, and adjacent beam segments of the remaining part of the plurality beam segments are connected with each other via a universal joint.

In some embodiments, the adjacent beam segments are connected with each other via a universal joint.

In some embodiments, the diameter-varying connecting member comprises: a first connector connected to one of adjacent beam segments; a second connector connected to the other of adjacent beam segments; and a connecting shaft connected the first connector with the second connector so that an inclination angle between an axial direction of the first connector and that of the second connector is variable.

In some embodiments, the first connector and the one of adjacent beam segment are connected via a bolt, the second connector and the other of adjacent beam segments are connected to the other of adjacent beam segments via a bolt.

In some embodiments, external diameters of the plurality beam segments of each beam are equal, and inner diameters of the plurality of the beam segments of each beam increase gradually along the direction from the connecting position between the beam and the swing bar to two ends of the beam.

In some embodiments, the inner diameter of each beam segment is constant.

In some embodiments, the inner diameter of each beam segment of each beam increases gradually along the direction from the connecting position between the beam and the swing bar to two ends of the beam.

In some embodiments, the connecting position between the swing bar and the beam is located at a middle point of the beam.

In some embodiments, a plurality of bearings are mounted at upper ends of the plurality of support bases, and the plurality of the beams are rotatably supported on the support bases via the bearings, respectively.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, among which:

FIG. 1 is a top view of a solar cell support assembly according to an embodiment of the present disclosure;

FIG. 2 is a perspective view of a solar cell support assembly according to an embodiment of the present disclosure;

FIG. 3 is an enlarged view of circle A in FIG. 1;

FIG. 4 is an enlarged view of circle B in FIG. 1; and

FIG. 5 is an enlarged view of circle C in FIG. 2.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

It is to be understood that phraseology and terminology used herein with reference to device or element orientation (such as, terms like “longitudinal”, “lateral”, “up”, “down”, “front”, “rear”, “left”, “right”, “vertical”, “horizontal”, “top”, “bottom”, “inside”, “outside”) are only used to simplify description of the present disclosure, and may not indicate or imply that the device or element referred to must have or operated in a particular orientation. They cannot be seen as limits to the present disclosure.

In the description, terms concerning attachments, coupling and the like, such as “connected” and “interconnected”, refer to a relationship in which structures are secured or attached to one another through mechanical or electrical connection, or directly or indirectly through intervening structures, unless expressly described otherwise. Specific implications of the above phraseology and terminology may be understood by those skilled in the art according to specific situations.

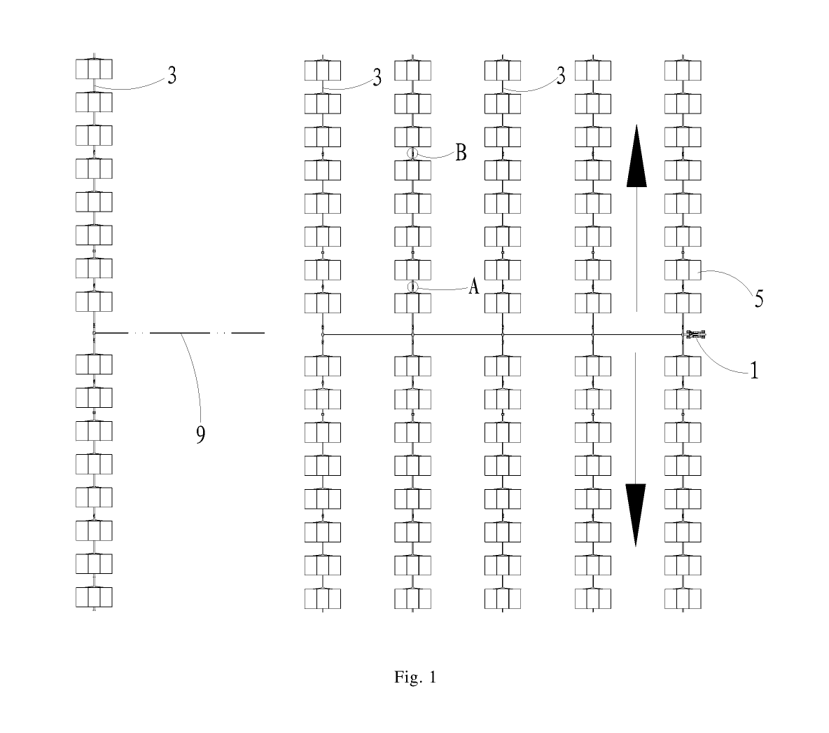

As shown in FIGS. 1-5, a solar cell support assembly according to certain embodiments is provided.

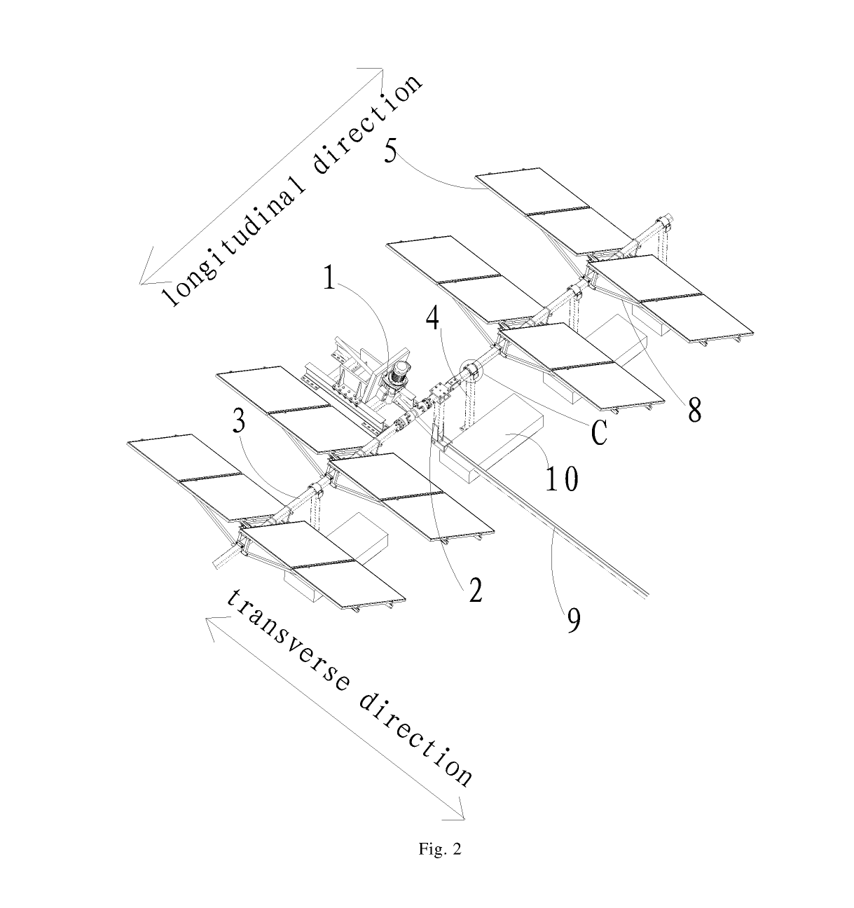

As shown in FIGS. 1-2, the solar cell support assembly includes a driving device 1, a pushrod 9, a swing bar 2, a plurality of beams 3 and a plurality of support bases 4.

The pushrod 9 is connected to the driving device 1 so as to be driven to move along the transverse direction. The pushrod 9 is pivotally connected to the swing bars 2, so that the swing bars 2 is driven to swing by the pushrod 9. The support bases 4 are disposed on the ground 10. A plurality of solar panels 5 are disposed on each beam 3 so as to form a solar cell array.

The beams 3 are extended in a longitudinal direction and spaced from one another in the transverse direction. The swing bars 2 are connected to the beams 3 correspondingly, and each of the beams 3 is rotatably supported on the support bases 4, so that the beams 3 can be driven to rotate on the support bases 4 via the swing movement of the swing bars 2. Each of the beams 3 is perpendicular to the pushrod 9 and configured as a hollow tube. The tube wall thickness of each beams 3 decreases gradually along a direction from a connecting position between the beam 3 and the swing bar 2 (i.e. points O as shown in FIG. 1) to two ends of the beam 3.

Therefore, when the solar cell support assembly operates, the pushrod 9 is driven to move by the driving device 1 (in the transverse direction shown in FIG. 2), then the swing bars 2 are driven to swing, so that each beam 3 is driven to rotate, and the solar panels 5 are rotated along with the rotations of the beams 3. Thus, the function of sun-tracking is achieved.

Because the driving force of the solar cell support assembly is merely provided by the driving device 1, a torque force applied on the beams is distributed uniformly. Therefore, the torque force applied on each beam may decrease along the direction from the connecting position between the beam and the swing bar to two ends of the beam due to the decrease of load, as indicated by arrows in FIG. 1. Accordingly, the tube wall thickness of each beam may decrease along the direction from the connecting position between the beam and the swing bar to two ends of the beam, so that the material of the beam can be saved, a probability of the ground subsidence decreases because the weight of the beams decreases, the stability of the solar cell system can be improved, and the solar cell support assembly can be adapted to be used in a large scale construction of ground power station.

In some embodiments, as shown in FIG. 1, each of the beams 3 includes a plurality of beam segments, and adjacent beam segments are connected with each other via at least one of a diameter-varying connecting member 6 and a universal joint. In other words, there are several kinds of connecting manners between adjacent beam segments: in a first connecting manner, adjacent beam segments are connected with each other via the diameter-varying connecting member, i.e., the beam segments of each beams are connected with each other via a diameter-varying connecting member; in a second connecting manner, adjacent beam segments are connected with each other via a universal joint; in a third connecting manner, adjacent beam segments of a part of the plurality of beam segments are connected with each other via a diameter-varying connecting member, and adjacent beam segments of the other part of the plurality of beam segments are connected with each other via a universal joint;

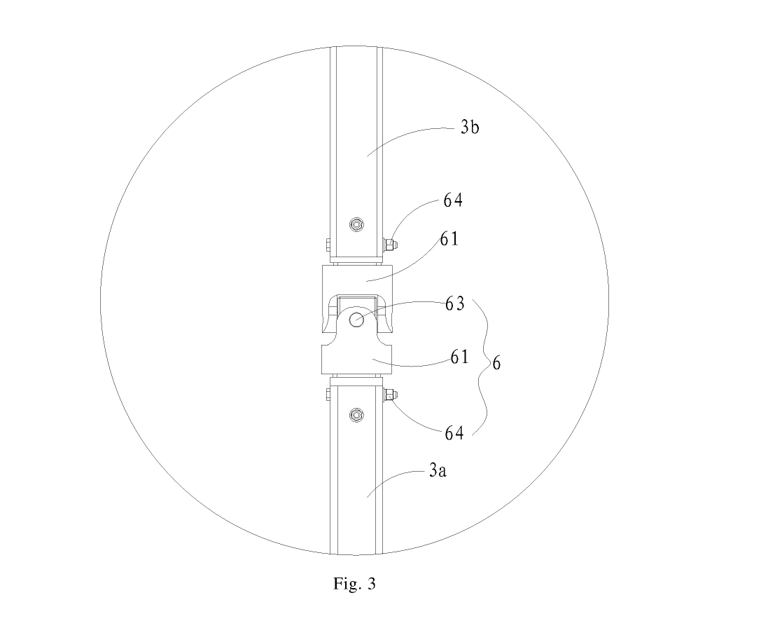

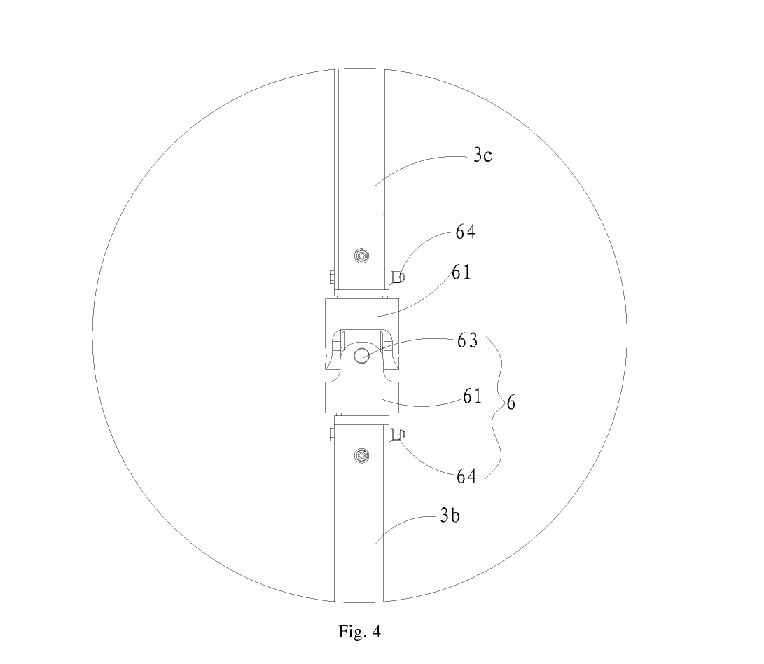

In some embodiments, as shown in FIGS. 3 and 4, the diameter-varying connecting member 6 includes a first connector 61 connected to one of adjacent beam segments, a second connector 62 connected to the other of adjacent beam segments, and a connecting shaft 63 pivotably connected with the first connector 61 and the second connector 62, in other words, an inclination angle between an axial direction of the first connector 61 and that of the second connector 62 is variable. Thus, the pivotal movement between the adjacent beam segments can be adapted to a height variance of the ground 10, and the solar cell support assembly is adapted to be mounted on uneven ground.

FIG. 3 shows a connecting relationship between the beam segment 3a and the beam segment 3b. A first connector 61 is connected with the beam segment 3a, and a second connector 62 is connected with the beam segment 3b. The external diameter of the beam 3a is equal to that of the beam 3b, and the inner diameter of the beam segment 3b is larger than that of the beam segment 3a because the beam segment 3b is located at a downstream of the beam segment 3a along the direction from the connecting position O between the beam 3 and swing bar 2 to two ends of the beam 3, which is to say, the tube wall thickness of the beam segment 3b is smaller than that of the beam 3a. Whereas, the force applied on the beam segment 3b is smaller than that on the beam segment 3a, and the change of the inner diameters between the beam segments 3a and 3b is corresponding to the change of the forces applied on the beam segments 3a and 3b, so that the stability of the solar cell support assembly is improved, the possibility of the ground subsidence is reduced, and the cost of the solar cell support assembly may be reduced.

As shown in FIG. 4, a connecting relationship exists between the beam segment 3b and the beam segment 3c which is located at a downstream of the beam segment 3b along the direction from the connecting position O between the beam 3 and swing bar 2 to two ends of the beam 3. A first connector 61 is connected with the beam segment 3b, and a second connector 62 is connected with the beam segment 3c. The external diameter of the beam segment 3c is equal to that of the beam segment 3b, and the inner diameter of the beam segment 3c is larger than that of the beam segment 3b, which is to say, the tube wall thickness of the beam segment 3c is smaller than that of the beam segment 3b. Whereas, the force applied on the beam segment 3c is smaller than that on the beam segment 3b, and the change of the inner diameters between the beam segments 3b and 3c is corresponding to the change of the forces on the beam segments 3b and 3c, so that the stability of the solar cell support assembly is improved, the possibility of the ground subsidence is reduced, and the cost of the solar cell support assembly may be reduced.

As shown in FIG. 3 and FIG. 4, the first connector 61 and the one of adjacent beam segments are connected via a bolt 64, and the second connector 62 and the other of adjacent beam segments are connected via a bolt 64.

In one embodiment, in the plurality of the beam segments of each beam 3, the inner diameters of the beam segments increase along the direction from the connecting position O between the beam 3 and swing bar 2 to two ends of the beam 3, and the external diameters of the beam segments are equal. Because the external diameters of the beam segments are constant, the components mounted on the beam 3 can be manufactured with a unified specification, thus, the cost of the solar cell support assembly can be reduced and it is advantageous for a standardized management of the components.

In one embodiment, the inner diameter of each beam segment of the beam 3 may be constant. That is to say, with each beam segment, the inner diameter is not changed along a length of the beam segment, which may be easy to manufacture the beam segments. In another embodiment, with each beams 3, the inner diameter of each beam segment increases along the direction from the connecting position O between the beam 3 and swing bar 2 to two ends of the beam 3. Therefore, the changes of the force applied on the beam segments are transferred uniformly, and the stability of the solar cell support assembly is improved.

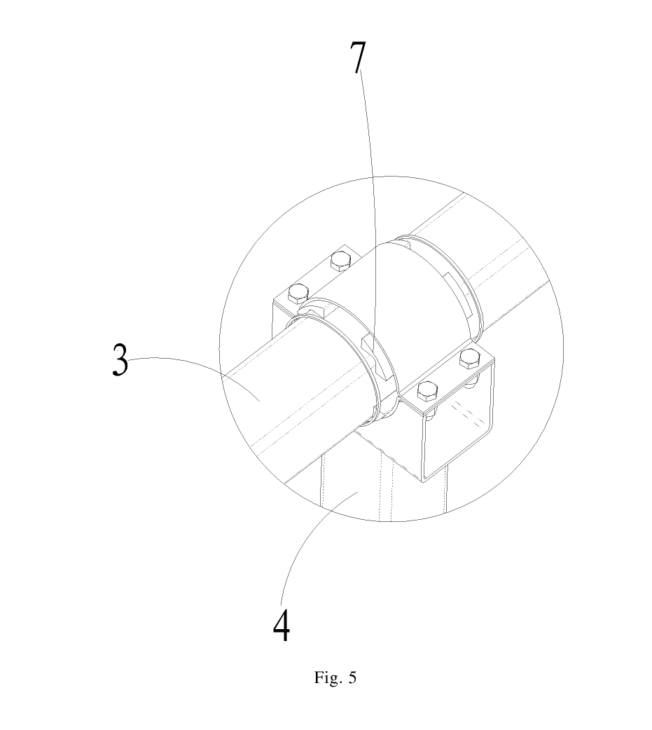

As shown in FIG. 5, in some embodiments, the solar cell support assembly further includes a plurality of bearings 7 mounted at upper ends of the plurality of support bases 4 respectively, and beams 3 are rotatably supported on the upper ends of the support bases 4 via the bearings 7 respectively. Therefore, the friction between the support base 4 and the beam decreases, and the operating life of the solar cell support assembly is extended.

As shown in FIG. 2, in some embodiments, the solar cell support assembly further includes a plurality of supporting members 8, and the solar panels 5 are respectively connected with each beam 3 via the supporting members 8. The supporting member 8 is known by those skilled in the related art, and will not be described in detail here.

Advantageously, the connecting position O between beam 3 and the swing bar 2 is located a middle point of the beam 3 in a length direction of the beam 3. Thus, forces applied on both sides of the each beam are uniform, and forces applied on the ground 10 are also uniform.

Certain components, such as the pushrod 9 and the supporting members 8, are known by those skilled in the related art, and will not be described in detail herein.

The FIGS. 1-5 are schematic diagrams of explanatory embodiments. Although the explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

1. A solar cell support assembly, comprising:
a plurality of support bases;
a plurality of swing bars;
a plurality of beams, extended in a longitudinal direction and spaced from one another in a transverse direction, the plurality of the beams connected to the plurality of the swing bars correspondingly, each of the beams rotatably supported on one of the plurality of the support bases and adapted to mount solar panels, each of the beams comprising a hollow tube, and a tube wall thickness of each beam decreasing gradually along a direction from a connecting position between the beam and the swing bar to two ends of the beam;
a pushrod connected to the plurality of the swing bars to drive the plurality of the swing bars to rotate the plurality of the beams, respectively; and
a driving device connected to the pushrod and configured to drive the pushrod to move along the transverse direction.

2. The solar cell support assembly according to claim 1, wherein each of the beams comprises a plurality of beam segments, and adjacent beam segments are connected with each other via at least one of a diameter-varying connecting member or a universal joint.

3. The solar cell support assembly according to claim 2, wherein the adjacent beam segments are connected with each other via the diameter-varying connecting member.

4. The solar cell support assembly according to claim 2, wherein adjacent beam segments of a part of the plurality beam segments are connected with each other via the diameter-varying connecting member, and adjacent beam segments of the remaining part of the plurality beam segments are connected with each other via the universal joint.

5. The solar cell support assembly according to claim 2, wherein the adjacent beam segments are connected with each other via the universal joint.

6. The solar cell support assembly according to claim 4, wherein the diameter-varying connecting member comprises:
a first connector, connected to one of adjacent beam segments;
a second connector, connected to the other of adjacent beam segments; and
a connecting shaft, connecting the first connector with the second connector so that an inclination angle between an axial direction of the first connector and that of the second connector is variable.

7. The solar cell support assembly according to claim 6, wherein the first connector and one of adjacent beam segments are connected via a bolt,
wherein the second connector and the other of adjacent beam segments are connected via a bolt.

8. The solar cell support assembly according to claim 2, wherein external diameters of the plurality of beam segments of each beam are equal, and inner diameters of the plurality of the beam segments of each beam increase gradually along the direction from the connecting position between the beam and the swing bar to two ends of the beam.

9. The solar cell support assembly according to claim 8, wherein the inner diameter of each beam segment of each beam is constant.

10. The solar cell support assembly according to claim 8, wherein the inner diameter of each beam segment of each beam increases gradually along the direction from the connecting position between the beam and the swing bar to two ends of the beam.

11. The solar cell support assembly according to claim 1, wherein the connecting position between the swing bar and the beam is located at a middle point of the beam.

12. The solar cell support assembly according to claim 1, wherein a plurality of bearings are mounted at upper ends of the plurality of the support bases, and the plurality of the beams are rotatably supported on the support bases via the bearings, respectively.
